(19) United States
(12) Patent Application Publication
(10) Pub. No.: US 2014/0240915 A1
(43) Pub. Date: Aug. 28, 2014

(54) KEYING SOLUTION

(71) Applicants: Andrew James Phelan, Magnolia, TX (US); John P. Franz, Houston, TX (US); James Jeffery Schulze, The Woodlands, TX (US); Kelly K. Smith, Spring, TX (US); Everett R. Salinas, Pasadena, TX (US)

(72) Inventors: Andrew James Phelan, Magnolia, TX (US); John P. Franz, Houston, TX (US); James Jeffery Schulze, The Woodlands, TX (US); Kelly K. Smith, Spring, TX (US); Everett R. Salinas, Pasadena, TX (US)

(21) Appl. No.: 14/350,371

(22) PCT Filed: Nov. 1, 2011
(86) PCT No.: PCT/US2011/058696

§ 371 Date: Apr. 8, 2014

(51) Int. Cl. G06F 1/18

(52) U.S. Cl. CPC G06F 1/187; G06F 1/182
USPC 361/679.31; 312/223.2

(57) ABSTRACT

A drive carrier includes a bezel and opposing sidewalls connected to the bezel. At least one of the opposing sidewalls includes a plurality of slots that form at least part of a keying solution, and a dimension of at least two of the plurality of slots is not the same.

### BACKGROUND

Drive enclosures (also known as drive cages) are mechanical devices typically used to house a plurality of drive assemblies. Each drive assembly may be inserted into one of the plurality of drive bays within the drive enclosure, and may comprise a drive disposed within a drive carrier. The drive may be, for example, a hard disk drive (HDD) that is configured to store information in the form of binary data bits. The drive carrier may be, for example, an enclosure that partially encases the drive and serves to hold the drive in a particular position within the drive bay, and to protect the drive from electromagnetic energy interference (EMI) that may be caused by neighboring drives.

### BRIEF DESCRIPTION OF THE DRAWINGS

Example embodiments are described in the following detailed description and in reference to the drawings, in which:

FIG. 1 depicts a system in accordance with embodiments;

FIG. 2 depicts a drive enclosure and drive carrier implementing a multi-dimensional keying solution in accordance with embodiments;

FIG. 3 depicts a three-dimensional view of a drive carrier implementing a multi-dimensional keying solution in accordance with embodiments;

FIG. 4 depicts a three-dimensional view of an inner portion of a drive enclosure implementing a multi-dimensional keying solution in accordance with embodiments;

FIG. 5 is a table depicting examples of how different drive bay flange combinations may allow or prevent access of drive carriers with different slot configurations in accordance with embodiments;

FIG. 6 depicts a drive enclosure incorporating rails in accordance with embodiments;

FIG. 7(a) depicts a rail in accordance with embodiments;

FIG. 7(b) depicts a rail in accordance with embodiments;

FIG. 8 depicts a rail attached to a drive enclosure in accordance with embodiments; and

FIG. 9 depicts a rail in accordance with embodiments.

### DETAILED DESCRIPTION

Typical drive enclosures may include components to assist with the insertion of a drive assembly into a drive bay, and to prevent insertion of a non-conforming drive assembly into the drive bay. For example, a drive enclosure may include flanges that protrude from the enclosure sidewall and mate with slots in the drive carrier to produce a keying feature that prevents insertion of a non-conforming drive assembly into a drive bay. A drive enclosure may further include one or more forms protruding from the enclosure sidewalls to guide a drive assembly during insertion and to support the drive assembly thereafter.

While implementations of the above-mentioned insertion features have been adequate in the past, such insertion features have proven to be inadequate for recent drive enclosure/assembly designs. For example, due to drive enclosure/assembly space restrictions in recent designs, keying features have been constrained in the number of insertion scenarios supported, and therefore may not protect all potential drive insertion scenarios. Users could therefore potentially damage a drive, backplane, and/or connector by inserting a non-conforming drive assembly into a drive bay that is not covered by the keying feature. Furthermore, due to large drive densities in current systems, the thickness of guide forms protruding from the enclosure walls has decreased. As a result, a user could potentially insert a drive assembly in a skewed manner and make the drive assembly ride against the form instead of positioning the drive assembly in its proper position above or below the form.

Embodiments described herein address at least the above-described issues by providing a “multi-dimensional” keying solution that enables a far greater number of drive insertion scenarios to be supported than typical keying solutions. In particular, unlike typical keying solutions that generally include a plurality of flanges in one-dimension protruding from the enclosure sidewall, embodiments utilize flanges in multiple dimensions to produce a multi-dimensional arrangement that supports more insertion scenarios. In addition, unlike current keying solutions that generally include a plurality of slots in the drive carrier with the same dimensions, embodiments utilize slots of different dimensions to mate with the multi-dimensional flanges on the drive enclosure. As a result, a multi-dimensional keying solution is realized that overcomes the constraints associated with current keying solutions. In particular and as discussed in greater detail below, the multi-dimensional keying solution may cover many more insertions scenarios that typical keying solutions, and may therefore reduce the risk of a user damaging a drive, backplane, and/or connector by inserting a non-conforming drive into a drive bay.

Furthermore, embodiments described herein address at least the above-mentioned skewed drive insertion issue by incorporating a rail into the drive enclosure to supplement the one or more forms protruding from the sidewall of the enclosure. The introduction of a rail in the enclosure may ensure that a drive is not inserted in a skewed manner into a drive bay. In addition, the rail may provide increased drive support because it may be thicker and protrude from a wall further than a typical form.

Some embodiments are directed to a drive carrier. The drive carrier comprises a bezel and opposing sidewalls connected to the bezel. At least one of the opposing sidewalls comprises a plurality of slots that form at least part of a keying solution, and a dimension of at least two of the plurality of slots is not the same. In embodiments, the dimension may be the depth, width, and/or thickness of the at least two slots. Furthermore, in embodiments, the plurality of slots may mate with a plurality of flanges protruding from the drive enclosure, and at least two of the plurality of flanges protruding from the drive enclosure may not be located within the same column or the same row.

Further embodiments are directed to a system. The system comprises a drive enclosure, a plurality of drives, and a plurality of drive carriers. The drive enclosure includes a plurality of drive bays, where each of the plurality of drive bays comprises a plurality of flanges protruding from a wall of the drive enclosure to form at least part of a keying solution. The plurality of drive carriers encase at least part of the plurality of drives, and a sidewall of each of the plurality of drive carriers comprises a plurality of slots that form at least part of the keying solution, where a dimension of at least two of the plurality of slots is not the same. In embodiments, the dimension may be the depth, width, and/or thickness of the at least two slots. Moreover, in embodiments, the plurality of slots may mate with a plurality of flanges protruding from the drive enclosure, and at least two of the plurality of flanges protruding from the drive enclosure may not be located within the same column or the same row. In some embodiments, at least one of the plurality of drive carriers may be supported on the underside by a rail when the drive carrier is located in a position within the drive bay. The rail may protrude at least 4 mm from the wall of the drive enclosure. Alternatively or in addition, a form may be positioned above the at least one of the plurality of drive carriers, and the drive may be located between the form and the rail. The rail may protrude further than the form from the wall of the drive enclosure, and the rail may form at least part of the keying solution.

Still further embodiments are directed to a system. The system comprises a drive carrier and a drive enclosure including a plurality of drive bays. The drive carrier may include a plurality of slots within a sidewall, where at least two of the plurality of slots have a different depth. At least one of the plurality of drive bays may include a plurality of flanges protruding from a wall, and at least two of the plurality of flanges protruding from the wall may not be located within the same column or the same row. In some embodiments, the drive carrier may be supported on the underside by a rail when the drive carrier is located in a position within one of the plurality of drive bays within the drive enclosure.

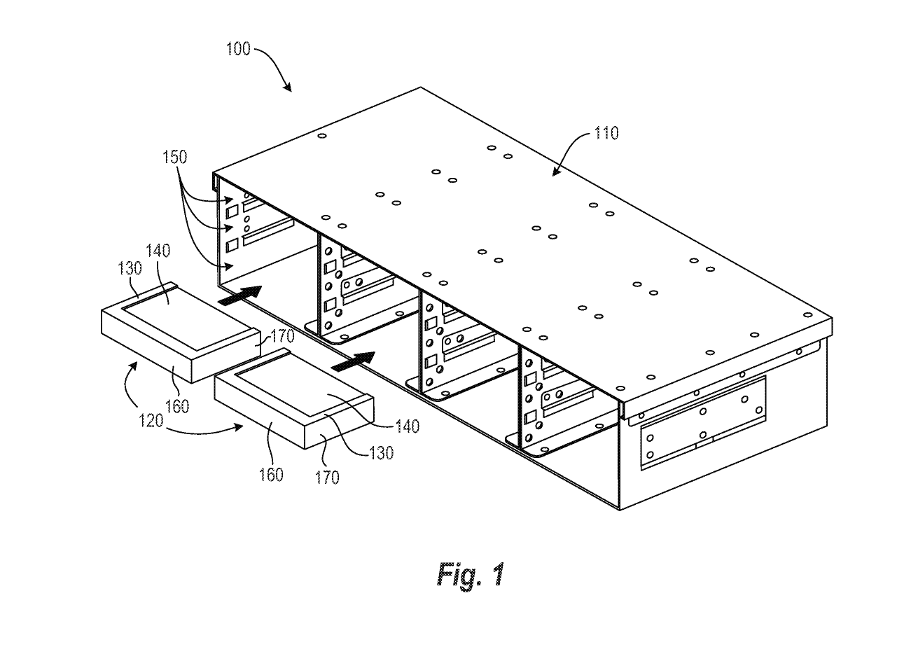

FIG. 1 depicts a system 100 in accordance with embodiments. The system 100 comprises a drive enclosure 110 and a plurality of drive assemblies 120. Each drive assembly 120 may be inserted into one of the plurality of drive bays 150 within the drive enclosure 110. Each drive assembly 120 may comprise a drive carrier 130 and a drive 140 installed within the drive carrier.

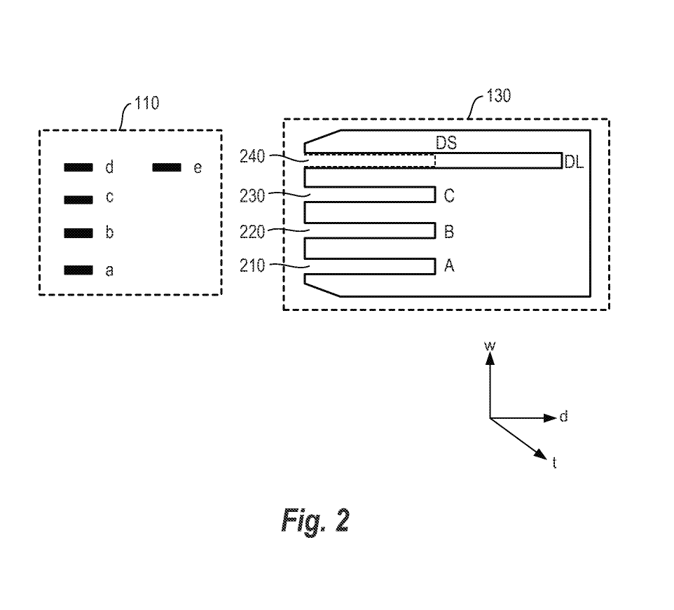

The drive enclosure 110 may be constructed of metal, plastic, and/or other suitable materials. For example, the drive enclosure 110 may be a sheet metal enclosure constructed of aluminum and/or steel. The drive enclosure 110 may include a plurality of walls, including external enclosure walls and internal enclosure walls. The drive enclosure 110 may include a plurality of drive bays 150 arranged in a vertical and/or horizontal manner. The drive bays 150 may be configured to receive and support a plurality of drive assemblies 120. The drive enclosure 110 may include forms, rails, and/or flanges protruding from the walls of the drive enclosure 110, as discussed in greater detail below with respect to FIGS. 2-9. Although the drive assemblies 120 are shown inserting into horizontal-oriented drive bays 150, it should be understood that the drive assemblies 120 could also be inserted into the vertical-oriented drive bays 150.

The drive assembly 120 may comprise a drive carrier 130 and a drive 140. The drive carrier 130 may be constructed of plastic, metal, and/or other materials. The drive carrier 130 may include a front plate or bezel 160, opposing sidewalls 170, and/or. a floor. A drive 140, such as a hard disk drive (HDD), solid state drive (SSD), or hybrid drive, may be placed within and/or attached to the area formed by the opposing sidewalls 170, floor, and/or bezel 160. A HDD may use, for example, spinning disks and movable read/write heads. A SSD may use, for example, solid state memory to store persistent data, and use microchips to retain data in non-volatile memory chips. A hybrid drive may combine features of the HDD and SSD into one unit containing a large HDD with a smaller SSD cache to improve performance of frequently accessed files. Other types of drives 140 such as flash-based SSDs, enterprise flash drives (EFDs), and the like may also be placed within and/or attached to the area formed by the opposing sidewalls 170, floor, and/or bezel 160.

One or more connectors (not shown) may be affixed to the drive 140. The connectors may be standard connectors configured to mate with a corresponding connector on a backplane. Different types of drives 140 may have different types of connectors. For example, the drives and/or associated connectors may be configured in accordance with the small computer system interface (SCSI), serial attached SCSI (SAS), serial advanced technology attachment (SATA), or the like. Because one or more of these drives and/or associated connectors may not be compatible with one another, a keying feature may be included in the drive bay and drive carrier to prevent insertion of a non-conforming drive into the drive bay. As discussed in greater detail below with respect to FIG. 2, this keying feature may be a multi-dimensional keying solution that enables a greater number of drive insertion scenarios to the be covered than typical single-dimension keying solutions.

FIG. 2 depicts a drive enclosure 110 and drive carrier 130 implementing a multi-dimensional keying solution in accordance with some embodiments. More precisely, FIG. 2 depicts a plurality of flanges arranged in a multi-dimensional pattern protruding from a drive bay wall. The plurality of flanges are represented by letters “a”-“e”. The flanges are multi-dimensional because the flanges are not all situated in one dimension. That is, for example, slot “e” is situated in a different column and different row than slot “a.” This differs from typical flange arrangements where all flanges are in the same row or column (i.e., single dimensional).

FIG. 2 further depicts plurality of slots in a drive carrier sidewall arranged in a multi-dimensional pattern. The plurality of slots are represented by letters “A”-“D” (where “DS” denotes short D and “DL” denotes long D). The slots are multidimensional because the slots have different dimensions. For example, slot “D” has a large depth (d) than slots “A,” “B,” and “C.” This differs from typical slot arrangements that have slots of equal depth (i.e., single dimensional).

For purposes of consistency and the ease of understanding, the identifiers and the slot/flange arrangement of FIG. 2 will be used throughout the remainder of the description and figures. It should be understood, however, that other arrangements may be used in accordance with embodiments. For example, there could be more or less slots and/or flanges in embodiments. For instance, instead of two columns of flanges, there could be three, four, or five columns of flanges, and wider slots to accommodate these additional flanges. Similarly, instead of four rows of flanges, there could be five or six rows of flanges and additional slots to accommodate these additional flanges. Furthermore, the multidimensional keying solution is not limited to variable depths. Rather or in addition, the multi-dimensional keying solution could utilize flanges and/or slots of different widths (w) and/or thicknesses (t). For example, the widths of the plurality of flanges and slots may vary to produce a multi-dimensional keying solution that inhibits or allows insertion of a drive assembly based at least in part on the width (w) of slots in the drive carrier. Furthermore, the thicknesses (t) of the plurality of flanges and slots may vary to produce a multi-dimensional keying solution that inhibits or allows insertion of a drive assembly based at least in part on the thickness of slots in the drive carrier. In some embodiments, insertion of the drive assembly may be dependent upon a combination of the depth, width, and/or thickness of the flanges and/or slots. This point notwithstanding, the below description focuses on variable depth for consistency and simplicity.

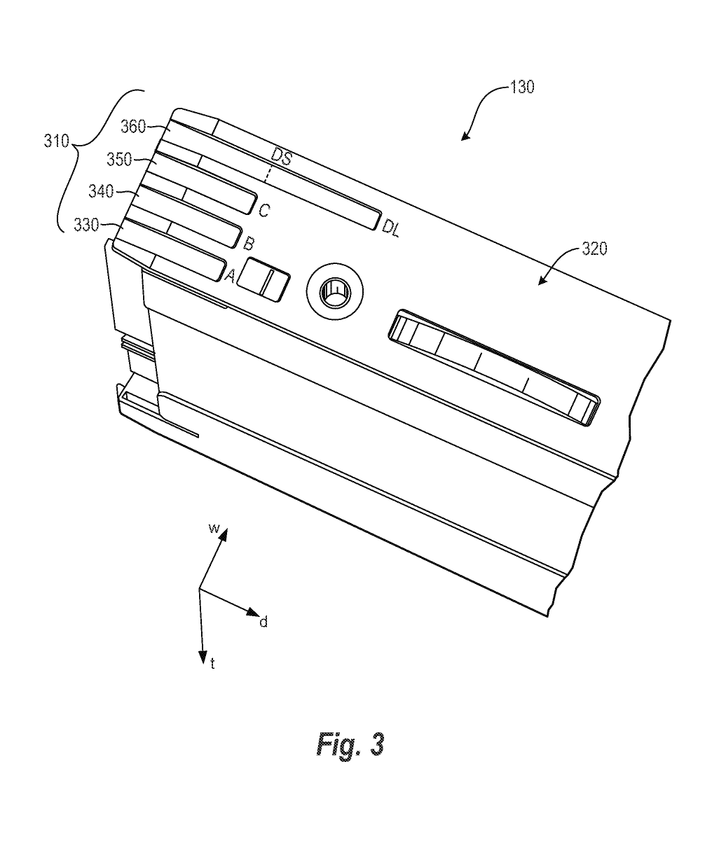

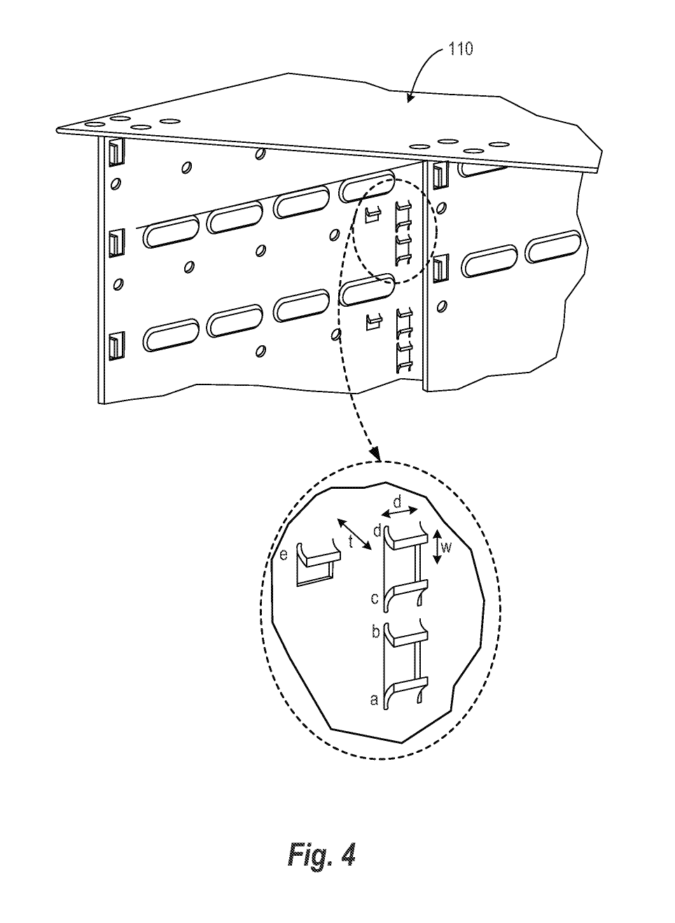

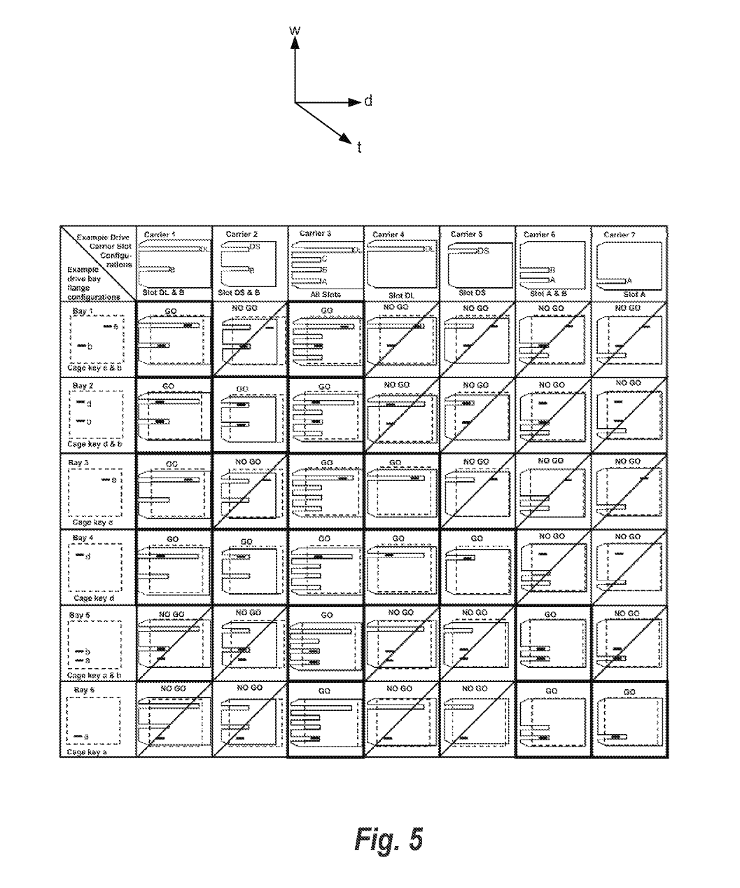

The example arrangement in FIG. 2 depicts a multi-dimensional keying approach utilizing flanges in separate rows and columns (contrary to a typical keying solution which may have a plurality of flanges in the same column). For example, flange “e” is in a different column and a different row than flange “a.” The example arrangement in FIG. 2 further depicts a multi-dimensional keying approach utilizing slots of different depths (contrary to a typical keying solution which may have a plurality of slots with the same depth). For example, slot “D” has a different depth than slot “A.” Use of slot “D” with a large depth, as described in greater detail below, enables a far greater number of insertion scenarios to be supported than standard keying approaches. Moreover, this multi-dimensional approach may enable, for example. SAS drives to be inserted into SAS and SCSI drive bays, but prevent the SCSI drive from being inserted into the SAS drive bay. Similarly, this multi-dimensional approach may enable, for example. SATA drives to be inserted into SATA and SCSI drive bays, but prevent the SCSI drive from being inserted into the SATA drive bay. This capability is described in greater detail with reference to the example drive insertion scenario chart in FIG. 5, which is provided after the detailed discussion about the configuration of the drive enclosure 110 and drive carrier 130 below with reference to FIGS. 3 and 4.

FIG. 3 depicts a three-dimensional view of a drive carrier 130 implementing a multi-dimensional keying solution in accordance with embodiments. As shown, the key slots 310 appear at the rear of one of the drive carrier sidewalls 320. It is noted, however, that the key slots 310 may be located in other locations. For example, the key slots 310 may be located on the other drive carrier sidewall or on both sidewalls in accordance with embodiments. Furthermore, while four key slots 310 are depicted, it should be understood that there could be more or less key slots in accordance with embodiments. In addition, while the depth of the slots 310 is different in FIG. 3, it should be understood that the width and/or thickness of the slots 310 may be different in embodiments.

Each key slot 310, when mated with the flanges protruding from the wall of the drive enclosure (see FIG. 4), form a portion of a keying solution to protect against insertion of a non-conforming drive. In particular, the right combination of key slots 310 on the drive carrier 330 and flanges on the drive enclosure (see FIG. 4) allows a drive to be inserted fully into the drive enclosure and properly interfaced with a backplane connector. In contrast, the wrong combination of key slots 310 on the drive carrier 330 and flanges on the drive enclosure (see FIG. 4) causes a hard-stop interference and prevents setting of the drive.

The example slot configuration in FIG. 3 utilizes four key slots (330-360) of different depth. Consistent with FIG. 2, the first key slot 330 is represented by letter “A.” The second key slot 340 is represented by letter “B.” The third key slot 350 is represented by letter “C.” The fourth key slot 360 is represented by letter “D.” Slot “D” differs from slots “A,” “B,” and “C” insofar as it has a greater depth. Slot “D” can therefore be “sub-divided” and represented by DS (short) and DL (long). As discussed below with reference to FIG. 5, this sub-division due to the greater depth provides more keying solutions than typical drive carriers that, at best, may have a plurality of slots with the same depth (d).

FIG. 4 depicts a three-dimensional view of an inner portion of a drive enclosure 110 implementing a multi-dimensional keying solution in accordance with embodiments. Similar to the drive enclosure referenced in FIG. 2, FIG. 4 depicts a plurality of flanges protruding from the enclosure wall. The plurality of flanges follow the pattern depicted in FIG. 2 and include flanges “a,” “b,” “c,” “d,” and “e.” Flanges “a,” “b,” “c,” and “d” are located in same column and flange “e” is located in a separate column. Flanges “e” and “d” are located in the same row. Some flanges may be downward facing (e.g., flanges “b”, “d,” and “e”), while other flanges may be upward facing (e.g., flanges “a” and “c”). The depth (d) of each of the plurality of flanges may be larger than the width (w) and/or thickness (t). This large depth may provide added strength to the flanges so that each may withstand impact from an inserted drive without bending or otherwise deforming.

It should be noted that while FIG. 4 illustrates a drive enclosure 110 with flanges “a”-“e”, implementations of the keying solution may require only one or more flanges to produce a keying arrangement. For example, a keying solution may not include all of flanges “a”-“e”. Furthermore, a drive enclosure 110 may have one drive bay with a particular flange arrangement to allow insertion of a particular drive assembly, and another drive bay in the drive enclosure 110 may have a different flange arrangement to allow insertion of a different drive assembly, as illustrated below in FIG. 5.

FIG. 5 is a table depicting examples of how different enclosure flange combinations may allow or prevent access of drive carriers with different slot configurations in accordance with embodiments. For each potential drive bay flange combination (see bays 1-6 in vertical direction), the table indicates whether a potential drive carrier slot combination (see carriers 1-6 in the horizontal direction) would be allowed or stopped. With regard to the flange combinations, it is noted that each example includes one or more flanges with locations and identifiers commensurate with those set forth in FIGS. 2 and 4. Similarly, with regard to the drive carrier slot combinations, it is noted that each example includes one or more slots with locations and identifiers commensurate with those set forth in FIGS. 2 and 3. The flange configurations, therefore, include flanges with identifiers “a”-“e”, and the drive carrier slots include slots with identifiers “A”-“D”, where the “D” slot can either be short (“DS”) or long (“DL”). While shown as slots with different depths, it should be understood that one or more slots may have different widths and/or thicknesses in accordance with embodiments. Moreover, while shown as flanges in different row/columns, it should be understood that one or more flanges may have different widths and/or thicknesses in accordance with embodiments.

In various embodiments, Drive Bay 1-Drive Bay 6 may be keyed for SAS, SCSI, SATA, and/or other similar drives. Similarly, Drive Carriers 1-7may be keyed for SAS, SCSI, SATA, and/or other similar drives assemblies. In addition, one or more of Drive Carriers 1-7may be for hot-plug or non-hot plug drives.

Turning now to the details of the table in FIG. 5, beginning with Drive Bay 1, this drive bay includes flanges “b” and “e” in separate columns protruding from the sidewall. In order for a drive carrier to be inserted completely into Drive Bay 1, the drive carrier must therefore have appropriate slots to mate with flanges “b” and “e.” Flange “b” mates with slot “b,” as shown in FIG. 2. Flange “e” mates with slot “DL,” as shown in FIG. 2. The location of flange “e” necessitates a deeper slot due to its multi-dimensional location in a separate column from the other flanges. Looking at the various drive carriers in the table, only Drive Carrier 1 and Drive Carrier 3 may be inserted properly into the Drive Bay 1. Drive Carrier 1 is appropriate because it includes slots “B” and “DL.” Drive Carrier 3 is appropriate because it includes slots “A,” “B,” “C,” and “DL.” The remaining drives carriers will be prevented from insertion into Drive Bay 1 because each does not have slots “B” and/or “DL.” Drive Carrier 2, in particular, includes “DS,” but because DS is a short “D” slot as opposed to a long “D” slot, it is blocked.

Moving on to Drive Bay 2, this drive bay includes flanges “b” and “d” in the same column. As shown in FIG. 2, therefore, a drive carrier with slots “B” and “D” may be inserted into Drive Bay 2. Drive Carriers 1-3 meet this requirement and are therefore appropriate for Drive Bay 2. Drive Carriers 4-7, by contrast, do not have slots “B” and/or “D,” and therefore are not appropriate. It should be noted that the placement of flange “d” enables drive carriers with DS or DL to be inserted. Thus, Drive Carrier 1 with slot DL or Drive Carrier 2 with slot DS may be inserted into Drive Bay 1. However, Drive Carrier 2 with slot DS cannot be inserted into Drive Bay 1. That is, even though Drive Carriers 1 and 2 both include D slots, Drive Carrier 1 has more insertion options that Drive Carrier 2 due to its D slot depth being larger. This is just one example of how the multi-dimensional keying enables more insertion scenarios to be covered by using different depth slots and flanges in different rows/columns.

Turning now to Drive Bay 3, this drive bay includes only flange “e.” As shown in FIG. 2, only drive carriers with slot “DL” will properly mate. Therefore, Drive Carriers 1, 3, and 4 will properly mate, and Drive Carriers 2 and 5-7 will be blocked.

With regard to Drive Bay 4, this drive bay includes only flange “d.” Hence, and as shown in FIG. 2, drive carriers with slots “DS” or “DL” will properly mate. Drive Carriers 1-5, therefore, will properly mate, and Drive Carriers 6 and 7 will be blocked.

As to Drive Bay 5, this drive bay includes flanges “a” and “b.” The proper drive carrier requires corresponding slots “a” and “b.” Drive Carriers 3 and 6 meet this requirement, and therefore these drive carriers may be inserted, while Drive Carriers 1, 2, 4, 5, and 7 will be blocked.

With regard to Drive Bay 6, this drive bay includes only flange “a.” Thus, only Drive Carriers 3, 6, and 8 may be properly inserted because they include slot “A.”

FIG. 5 depicts various example drive bay flange configurations and drive carrier slot configurations to illustrate the benefit of the multi-dimensional keying approach. Of course, additional and/or alternate flange configurations and/or slot configurations may be used in accordance with embodiments. For example, instead of flanges “a”-“e” spanning two columns, flanges could span three, four, or five columns in accordance with embodiments to provide additional keying options. Further, instead of only slot D being in a large depth format, a plurality of slots may be in the large depth format. Alternatively or in addition, the slots may have different widths and/or thicknesses to provide alternative or additional keying options. Further, the flanges may have different widths and/or thicknesses to provide additional keying options.

In addition to the above-discussed multi-dimensional keying arrangement, embodiments further advance drive enclosure 110 and drive assembly 120 mating by incorporating rails into the drive enclosure to supplement or replace forms protruding from the sidewall of the enclosure. More specifically, embodiments introduce thin rails or ledges into the enclosure to ensure that a drive is not inserted in a skewed manner into a drive bay, to provide additional keying options, and/or to provide additional drive assembly support. As used herein, the term “form” or “forms” refers to a raised area of a drive enclosure wall created from the base material through a deformation process. For example, the form may be a raised area of sheet metal protruding from the drive enclosure wall in the shape of a rectangle with rounded ends (i.e., a racetrack shape). Alternatively, the form may be, for example, a raised area of sheet metal protruding from the drive enclosure wall in the shape of a cylinder. Other form shapes may also be used.

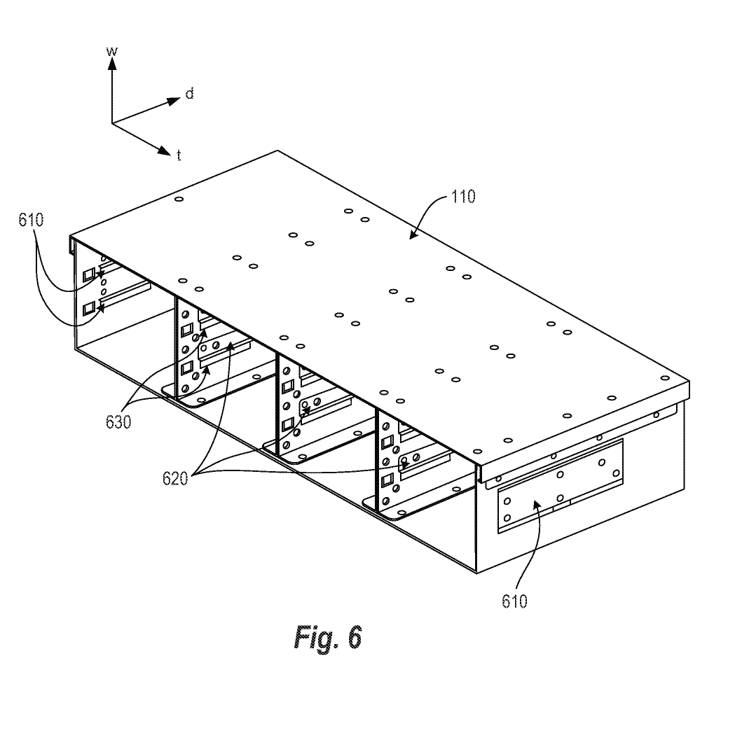

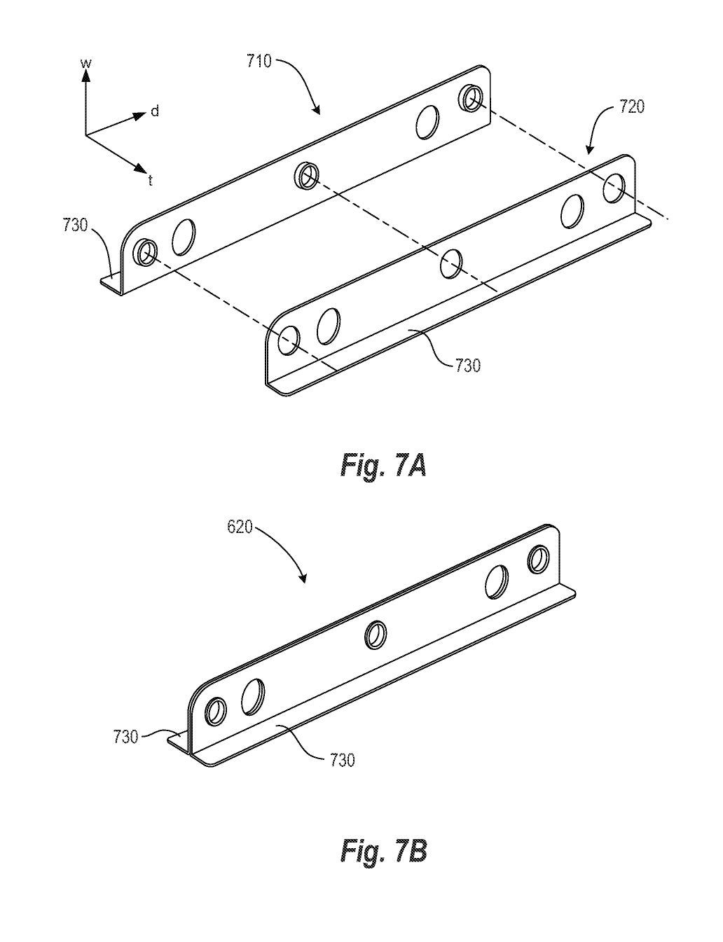

FIG. 6 depicts a drive enclosure 110 incorporating the above-mentioned rails in accordance with embodiments. In particular, the drive enclosure 110 includes a unidirectional rail 610 on the outer walls of the drive enclosure 110, and a bidirectional rail 620 on the inner walls of the drive enclosure 110. Forms 630 may be positioned above and/or below the rails (610 and 620). As discussed in greater detail with reference to FIGS. 7-9, the unidirectional rail 610 may be, for example, a u-shaped bracket staked or otherwise attached to the exterior drive enclosure walls, and the bidirectional rail 620 may be, for example, two L-shaped brackets staked or otherwise attached together on an inner wall of the drive enclosure 110 and protruding in opposite directions from the inner wall. Depending on the location of the drive bay, one or more unidirectional 610 and/or bidirectional 620 rails may be used to guide and/or support a drive assembly 120. For example, a middle height drive bay may utilize a unidirectional rail 610 and a bidirectional rail 620 to guide a drive assembly 120 into the bay and to support the underneath of the drive assembly 120. The drive bay may further use a unidirectional rail 610 and a bidirectional rail 620 to guide the upper portion of the drive assembly 120 into the bay. In some embodiments, the unidirectional rail 610 and/or bidirectional rail 620 may provide support for the underneath of one drive assembly 120 and also guide the upper portion of another drive assembly 120. One or more forms 630 may also be included to guide and/or support the drive assembly 120. The rails (610 and 620), however, may protrude further from the drive enclosure walls than the forms 630 and therefore provide further guiding and/or support.

FIGS. 7(a) and 7(b) depict the bidirectional rail 620 in accordance with embodiments. As mentioned above, this bidirectional rail 620 may be attached to an inner wall of the drive enclosure 110. As further mentioned above, this bidirectional rail may comprise a left L-shaped portion 710 and a right L-shaped bracket 720 attached together (see FIG. 7(a)). Each L-shaped bracket 720 may attach to an inner wall of the drive enclosure 110 such that ledges 730 protrude in opposite directions from adjacent drive bays. Each L-shaped portion may comprise plastic and/or metal. In some embodiments, each L-shaped portion may be the same mirrored design. In other embodiments, the length, width, and/or height of the L-shaped portions may vary. The L-shaped portions may mate together via various mechanisms. For example, one L-shaped portion may have an extruded male stake and the other L-shaped portion may have a mating stake hole (see FIG. 7 (b)).

While not shown, in some embodiments, one or more portions of the bidirectional rail 620 may form a portion of a keying solution. For example, flanges of different thickness, depth, and/or width and location may protrude from the bidirectional rail 620 to form a keying solution similar the solutions described above with respect to FIGS. 2-5. Corresponding slots on the drive carrier may therefore be required to mate with the flanges on the rail and allow proper insertion of the drive assembly into the drive bay.

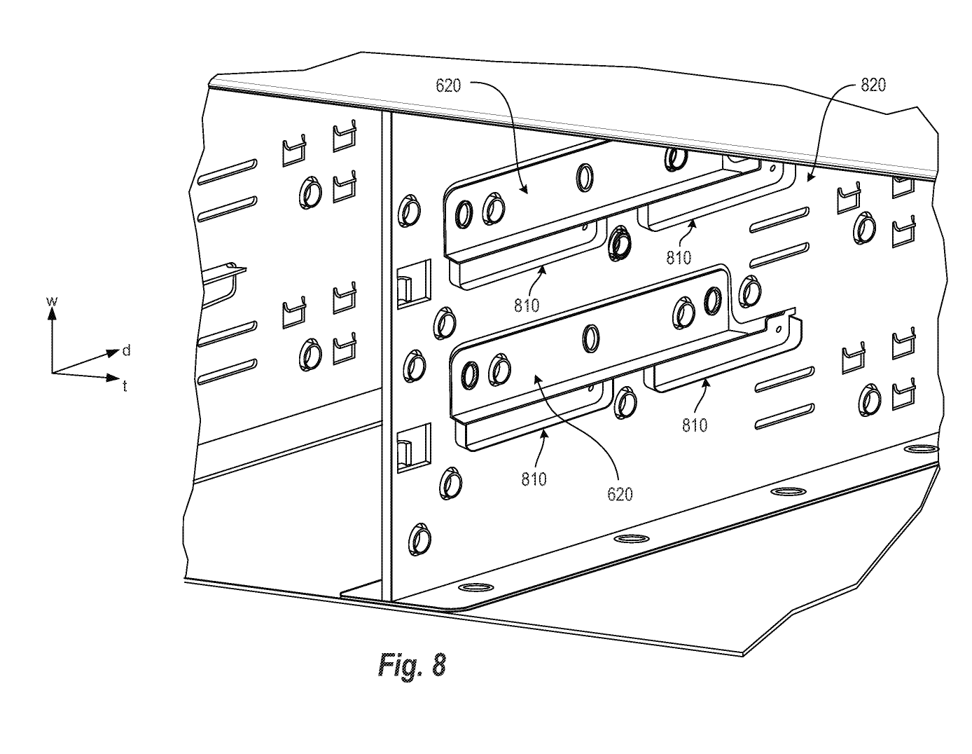

FIG. 8 depicts the bidirectional rail 620 attached to a drive enclosure in accordance with embodiments. More precisely, FIG. 8 depicts a perspective of a bidirectional rail 620 mounted in a drive bay. As shown, the bidirectional rail 620 is mounted above one or more forms 810. As further shown, the bidirectional rail 620 protrudes from the wall of the enclosure 820 further than the form 810 protrudes from the wall of the enclosure 820. For example, the bidirectional rail 620 may protrude at least 4 mm from the wall of the enclosure 820, and the form may protrude 2 mm or less. In some embodiments, the bidirectional rail may protrude 5.4 mm from the wall of the enclosure 820. Because the bidirectional rails 620 protrude this additional distance beyond the form 810, the rails 620 may provide better drive assembly guidance during insertion than a drive enclosure that only includes one or more forms. Consequently, the risk of a user inserting a drive assembly in a skewed manner may be reduced by the addition of the bidirectional rail 620. Furthermore, because the bidirectional rails 620 may protrude an additional distance beyond the form 810, the rails 620 may provide more support for the drive carrier than a drive enclosure that only includes forms.

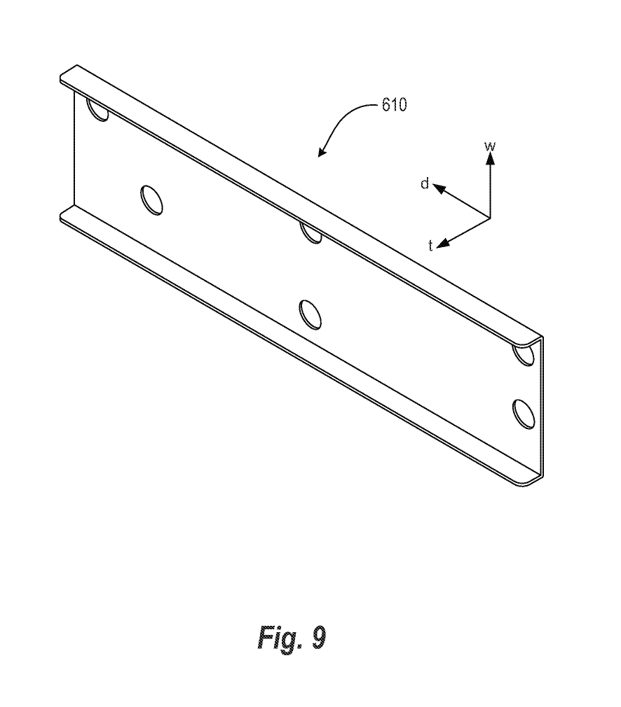

FIG. 9 depicts a unidirectional rail 610 in accordance with embodiments. As mentioned above, this unidirectional rail 610 may be affixed to one or more outer walls of a drive enclosure. In embodiments, a portion of the unidirectional rail 610 may be used to support and align the lower portion of a drive enclosure 120, and another portion of the rail 610 may be used to guide the upper portion of the drive enclosure. In some embodiments, a portion of the rail 610 may support the lower portion of one drive carrier while also being used to align the upper portion of another drive carrier. When installed, the rail 610 may protrude from an outer wall of an enclosure further than a proximate form. For example, the rail 610 may protrude at least 4 mm from the wall of the enclosure, and the form may protrude 2 mm or less. In some embodiments, the rail 610 may protrude 5.4 mm from the wall of the enclosure 820. Consequently, the risk of a user inserting a drive assembly in a skewed manner may be reduced by the addition of the unidirectional rail 610. Furthermore, because the unidirectional rail 610 may protrude an additional distance beyond the form, the rails 610 may provide more support for the drive carrier than a drive enclosure that only includes one or more forms.

While not shown, in some embodiments, one or more portions of the unidirectional rail 610 may form a portion of a keying solution. For example, flanges of different thickness, depth, and/or width and location may protrude from the unidirectional rail 610 to form a keying solution similar the solutions described above with respect to FIGS. 2-5. Corresponding slots on the drive carrier may therefore be required to mate with the flanges on the rail and allow proper insertion of the drive assembly into the drive bay.

Embodiments have been shown and described with reference to the foregoing examples. It is to be understood, however, that other details, arrangements, and embodiments may be made without departing from the spirit and scope of the disclosure.

What is claimed is:

1. A drive carrier comprising:
a bezel; and
opposing sidewalls connected to the bezel,
wherein at least one of the opposing sidewalls comprises a plurality of slots that form at least part of a keying solution, and
wherein a dimension of at least two of the plurality of slots is not the same.

2. The drive carrier of claim 1, wherein the dimension is the depth of the at least two slots.

3. The drive carrier of claim 2, wherein the plurality of slots mate with a plurality of flanges protruding from a drive enclosure, and wherein at least two of the plurality of flanges protruding from the drive enclosure are not located within the same column or the same row.

4. The drive carrier of claim 1, wherein the dimension is the width of the at least two slots.

5. The drive carrier of claim 1, wherein the dimension is the thickness of the at least two slots.

6. A system comprising:
a drive enclosure including a plurality of drive bays, wherein each of the plurality of drive bays comprises a plurality of flanges protruding from a wall of the drive enclosure to form at least part of a keying solution;
a plurality of drives; and
a plurality of drive carriers to encase at least part of the plurality of drives, wherein a sidewall of each of the plurality of drive carriers comprises a plurality of slots that form at least part of the keying solution, and wherein a dimension of at least two of the plurality of slots is not the same.

7. The system of claim 6, wherein the dimension is the depth of the at least two slots.

8. The system of claim 7, wherein the plurality of slots mate with a plurality of flanges protruding from a drive enclosure, and wherein at least two of the plurality of flanges protruding from the drive enclosure are not located within the same column or the same row.

9. The system of claim 6, wherein at least one of the plurality of drive carriers is supported on the underside by a rail when the at least one drive carrier is located in a position within one of the plurality of drive bays within the drive enclosure.

10. The system of claim 9, wherein the rail protrudes at least 4 mm from the wall of the drive enclosure.

11. The system of claim 9, wherein a form is positioned above the at least one of the plurality of drive carriers, and the drive carrier is located between the form and the rail.

12. The system of claim 11, wherein the rail protrudes further than the form from the wall of the drive enclosure.

13. The system of claim 9, wherein the rail forms at least part of the keying solution.

14. A system comprising:
a drive carrier comprising a plurality of slots within a sidewall, wherein at least two of the plurality of slots have a different depth; and
a drive enclosure including a plurality of drive bays, wherein at least one of the plurality of drive bays includes a plurality of flanges protruding from a wall, and wherein at least two of the plurality of flanges protruding from the wall are not located within the same column or the same row.

15. The system of claim 14, wherein the drive carrier is supported on the underside by a rail when the drive carrier is located in a position within one of the plurality of drive bays within the drive enclosure.
